(19) United States
(12) Patent Application Publication
(10) Pub. No.: US 2007/0137350 A1
(43) Pub. Date: Jun. 21, 2007

(54) Ball screw nut and method of producing the same

(75) Inventors: Koji Tateishi, Shizuoka-ken (JP); Yoshinori Ikeda, Shizuoka-ken (JP)

Correspondence Address: HARNESS, DICKEY & PIERCE, P.L.C., P.O. BOX 828, BLOOMFIELD HILLS, MI, 48303, US

(73) Assignee: NTN Corporation, Osaka (JP)

(21) Appl. No.: 10/571,374

(22) PCT Filed: Aug. 24, 2004
(86) PCT No.: PCT/JP04/12084

§ 371 Date: Jun. 27, 2006

(30) Foreign Application Priority Data
Sep. 11, 2003 (JP) 2003-319287
Sep. 16, 2003 (JP) 2003-322772

(51) Int. Cl. F16H 1/24

(52) U.S. Cl. 74/424.87

(57) ABSTRACT

A ball screw nut with a ball rolling groove where balls roll on the inner circumferential surface of the ball screw nut with the ball rolling groove formed by a surface generated by a tapping tool. A method of manufacturing a ball screw nut with a ball rolling groove where balls roll on the inner circumferential surface of the ball screw nut with a step of forming a predetermined inner circumferential surface at the center of a blank by a drilling tool. A step of generating the ball rolling groove by introducing a tapping tool into the inner circumferential surface. A step of heat treating to harden the surface of the ball rolling groove.

### CROSS-REFERENCE TO RELATED APPLICATIONS

This application is a National Stage of International Application No. PCT/JP2004/012084, filed Aug. 24, 2004, which claims priority to Japanese Patent Application No. 2003-319287, filed Sep. 11, 2003 and Japanese Patent Application No. 2003-322772, filed Sep. 16, 2003. The disclosures of the above applications are incorporated herein by reference.

### FIELD

The present disclosure relates to a ball screw nut formed with a helical ball rolling groove which accommodates a large number of rolling balls and a method for its manufacture.

### BACKGROUND

A ball screw is a mechanical element to convert rotational motion of a ball screw shaft or a ball screw nut into axial linear motion of the ball screw nut or the ball screw shaft. Ordinarily, the ball screw shaft is formed with a helical ball rolling groove on its outer circumferential surface. The ball screw nut is formed with a helical ball rolling groove on its inner circumferential surface. A plurality of balls are rollably contained within a ball rolling passage formed between oppositely arranged helical ball rolling grooves on the outer and inner circumferential surfaces.

The ball screw nut ball rolling groove is formed on its inner circumferential surface by cutting and grinding. First, a bore is drilled in a blank. The helical ball rolling groove is cut into a circumferential surface of the bore by a turning tool. A heat treatment, such as carburizing hardening, is then carried out. A bottom portion of the groove is ground and finally finish ground by a grinding stone.

However, there are several problems with conventional ball screw nuts which have a ball rolling groove formed by cutting and grinding. For example, in a case of grinding a ball screw nut having a small inner diameter, it is impossible to insert a grinding stone into the bore. In addition, in a case of a ball screw nut having a large lead angle, although it does not have a small inner diameter, it is likewise impossible to grind the groove since an amount of insertion of the grinding stone into the bore is limited due to its large lead angle. Further, grinding is disadvantageous since it requires significant labor and time in adjusting, centering of the nut, etc. which increases the manufacturing costs.

A ball screw nut shown in FIG. 12 is well known as one which can solve these problems. This ball screw nut 50 has a substantially cylindrical configuration with a flange 50a at one end to connect the nut 50 to any part of a machine, such as a transferring machine, etc. A ball rolling groove 50c is formed in an inner circumferential surface of the ball screw nut 50. A smooth cylindrical portion 50b is formed on an outer circumferential surface of the nut 50. Members such as a return pipe or bridge member, which connects one end of the ball rolling groove 50c to the other end, are provided on the smooth cylindrical portion 50b. The ball rolling groove 50c is formed, for example, as a Gothic arch configuration, a combination of two circular arcs, one having a larger radius of curvature, and the other having a smaller radius of curvature than the radius of ball.

This ball screw nut 50 is manufactured according to steps shown in FIG. 13. First, the outer circumferential surface of a cylindrical blank 51 is turned by a turning tool 52 to form a flange 51a (S1). A prepared bore 51b is formed by a drilling tool 53 (S2). After boring the prepared bore 51b to a predetermined dimension using a boring bar tool 54 (S3), the blank 51 is rotated at a low speed of 100˜200 rpm. A rolling tap 55 is inserted into the prepared bore 51b to form, by rolling (S4) the tap 55, a ball rolling groove 51c. Accordingly, the surface of the ball rolling groove 51c is burnished. Then a return portion 51d, to circulate balls, is formed using an end mill 56. The outer circumferential surface of the blank 51 is finished using a turning tool 52 (S5). Finally the rolling tap 55 is passed through the ball rolling groove 51c of the blank 51 to remove burrs(S6).

According to this manufacturing method, since the ball rolling groove 51c is formed on the inner circumferential surface of the blank 51 in the rolling step (S4), it is possible to eliminate the grinding step of the ball rolling groove using a grinding stone of the prior art. Thus, this method easily achieves machining of the ball rolling groove 51c although it is a ball screw nut of small diameter. Accordingly, it is possible to reduce the number of manufacturing steps as well as the lead time and thus the manufacturing cost of the ball rolling groove 51c (see Japanese Laid-open Patent Publication No. 88072/2000).

Recently, not only have machine tools and semiconductor manufacturing machines require accurate positioning, smooth and quiet operation, but transferring machines and press machines, not requiring such high accuracy and smooth and quiet operation, are required to operate at high speeds under low noise and vibration conditions. In the conventional ball screw nut 50 used for these machines, there are problems when forming the ball rolling groove 50c by cold plastic working. That is, since axial plastic flow of material of the hollow nut body can be scarcely expected, a large stress is caused in the rolling tap 55 inserted into the inner circumferential surface and thus the rolling tap 55 may be broken.

If attempts are made to reduce the amount of plastic deformation of the material of the ball screw nut in order to prevent breakage of the rolling tap, an improved accuracy of the ball rolling groove 50c would not be expected since non-worked portions would remain in the ball rolling groove 50c. Since no easy methods exist for forming the ball rolling groove of the ball screw nut with relatively high accuracy, and like methods do not exist for forming the ball rolling groove of the ball screw shaft, the current state of manufacturing ball screw nuts requires grinding the ball rolling groove even though it necessitates a high manufacturing cost.

Furthermore, if the ball screw nut 50 is formed by SCM steel (JIS) and carburizing hardening/tempering is applied, a grain boundary oxidation zone is formed in the surface layer. Thus, the surface of the ball rolling groove 50c becomes fragile and causes a reduction of hardness, which promotes wear of the ball rolling groove. In addition, foreign material entering into the worked surface (scratched surface or chatter) would worsen the hardenability and increase the grain boundary oxidation zone.

### SUMMARY

It is, therefore, an object of the present disclosure to provide a ball screw nut formed with a ball rolling groove with improved durability. The ball screw nut is able to be manufactured at a low cost and has a relatively high accuracy. Also provided is a method for manufacturing the ball screw nut.

According to the present disclosure, a ball screw nut is formed with a ball rolling groove where balls roll on the inner circumferential surface of the ball screw nut. The ball rolling groove is formed by a surface generated by a tapping tool.

The ball rolling groove is formed by a surface cut by a tapping tool. Thus, it is possible to provide a ball screw nut ball rolling groove formed with a relatively high accuracy at a low manufacturing cost.

The ball rolling groove is formed with a Gothic arch configuration in cross-section. Thus, it is possible to stably set the contacting point between the ball rolling groove and the balls. Thus, this obtains smooth rolling of the balls.

The surface roughness Ra is limited to be less than or equal to 1.2 μm. Thus, it is possible to suppress noise and vibration even though operation is at a high speed rotation.

A surface of the ball rolling groove is formed with a hardened layer within a range of 54˜64 HRC. Thus, it is possible to improve the durability against rolling fatigue.

According to the present disclosure, a method for manufacturing a ball screw nut formed with a ball rolling groove where balls roll on the inner circumferential surface of the ball screw nut comprises: forming a predetermined inner circumferential surface at a center of a blank with a drilling tool; generating the ball rolling groove by introducing a tapping tool into the inner circumferential surface; and heat treating to harden the surface of the ball rolling groove.

According to the manufacturing method, it is possible to provide a ball screw nut ball rolling groove with relatively high accuracy at a low manufacturing cost and with sufficient durability.

The ball rolling groove is formed by cutting under NC control based on information obtained by detecting the phases of the ball screw nut and the tapping tool. Thus, it is possible to efficiently form the ball rolling groove by one pass of the tapping tool. This achieves groove machining at low manufacturing cost and high accuracy.

The tip end portion of the tapping tool is formed as a cylindrical configuration guided through the inner circumferential surface. Thus, it is possible to achieve easy centering of the tapping tool and cutting with high accuracy.

A ball screw nut is formed with a ball rolling groove where balls roll on the inner circumferential surface of the ball screw nut. The ball rolling groove is formed with a layer hardened by shot peening.

The ball rolling groove is formed with a layer hardened by shot peening. Thus, it is possible to improve the surface roughness of the ball rolling groove and to increase the residual compressive stress of the groove surface. Accordingly, it is also possible to provide a ball screw nut ball rolling groove of relatively high accuracy formed at a low manufacturing cost and having high durability.

The surface roughness Ra is limited to be less than or equal to 1.0 μm. Thus, it is possible to suppress noise and vibration even though it operates at a high speed rotation.

The surface hardness Hv of the ball rolling groove is set within a range of 700˜900. Thus, it is possible to obtain sufficient wear resistance and durability.

The surface of the ball rolling groove has the residual compressive stress within a range of about −500˜−1500 MPa. Thus, it is possible to further improve the durability.

A method for manufacturing a ball screw nut formed with a ball rolling groove where balls roll on the inner circumferential surface of the ball screw nut comprises shot peening before and/or after the heat treatment of the ball screw nut. Accordingly, the shot peening is carried out before and/or after the heat treatment of the ball screw nut. Thus, it is possible to provide a ball screw nut ball rolling groove with relatively high accuracy formed at a low cost and with a durability adapted to fit the application conditions.

The method further comprises a step of forming a predetermined inner circumferential surface at the center of a blank by a drilling tool; and generating the ball rolling groove by introducing a tapping tool into the inner circumferential surface. Thus, it is possible to efficiently form the ball rolling groove by one pass of the tapping tool. Thus, this achieves groove machining at low manufacturing cost and high accuracy.

The shot peening may be carried out using silicon carbide beads having a particle size of 40˜60 μm. Thus, it is possible to improve the surface roughness, scratched surface and chatter of the ball rolling groove and to increase the surface hardness and residual compressive stress.

The shot peening may be carried out using steel beads having a particle size of 40˜60 μm. Thus, it is possible to provide a ball screw nut providing sufficient wear resistance and durability.

The ball rolling groove is formed by a surface cut by a tapping tool. Thus, it is possible to provide a ball screw nut with a ball rolling groove with a relatively high accuracy at a low manufacturing cost and with sufficient durability.

Also, since the method for manufacturing the ball screw nut comprises forming a predetermined inner circumferential surface at the center of a blank by a drilling tool, generating the ball rolling groove by introducing a tapping tool into the inner circumferential surface, and heat treating to harden the surface of the ball rolling groove, it is possible to provide a ball screw nut with a ball rolling groove having a relatively high accuracy at a low manufacturing cost and with sufficient durability.

The ball rolling groove is formed with a layer hardened by shot peening. Thus, it is possible to improve the surface roughness of the ball rolling groove and to increase the residual compressive stress of the groove surface. Accordingly, it is also possible to provide a ball screw nut with a ball rolling groove of relatively high accuracy formed at a low manufacturing cost and with high durability.

In addition, according to the method, the shot peening is carried out before and/or after the heat treatment of the ball screw nut. Thus, it is possible to provide a ball screw nut with a ball rolling groove of relatively high accuracy formed at a low cost and with durability adapted to fit the conditions.

A method for manufacturing a ball screw nut with a ball rolling groove where balls roll on the inner circumferential surface of the ball screw nut comprises forming a predetermined inner circumferential surface at the center of a blank by a drilling tool; generating the ball rolling groove by introducing a tapping tool into the inner circumferential surface; and heat treating, by carburizing hardening, the surface of the ball rolling groove.

### BRIEF DESCRIPTION OF THE DRAWINGS

Additional advantages and features of the present disclosure will become apparent from the subsequent description and the appended claims, taken in conjunction with the accompanying drawings, wherein:

FIG. 1 is a longitudinal section view of a ball screw nut of the present disclosure.

FIG. 2 is flowchart showing steps for manufacturing the ball screw nut of the present disclosure.

FIG. 3 is a schematic view of a turning center for carrying out the method of manufacturing the ball screw nut of the present disclosure.

FIG. 4 is an elevation view of a tapping tool used for manufacturing the ball screw nut.

FIG. 5 is a graph showing the surface roughness of the ball rolling groove of the ball screw nut.

FIG. 6 is a graph showing results of the life test of a ball screw with the ball screw nut of the present disclosure.

FIG. 7 is a flow chart showing other steps for manufacturing the ball screw nut.

FIG. 8 is a graph showing the surface hardness of the ball rolling groove of the ball screw nut.

FIG. 9 is a graph showing results of the life test of a ball screw with the ball screw nut of the present disclosure.

FIG. 10 is a flow chart showing further steps for manufacturing the ball screw nut of the present disclosure;

FIG. 11 is a graph showing results of the life test of a ball screw with the ball screw nut of the present disclosure.

FIG. 12 is a longitudinal section view of a ball screw nut of the prior art.

FIG. 13a-f are elevation views showing a method for manufacturing a ball screw nut of the prior art.

### DETAILED DESCRIPTION

Embodiments of the present invention will be described with reference to accompanying drawings.

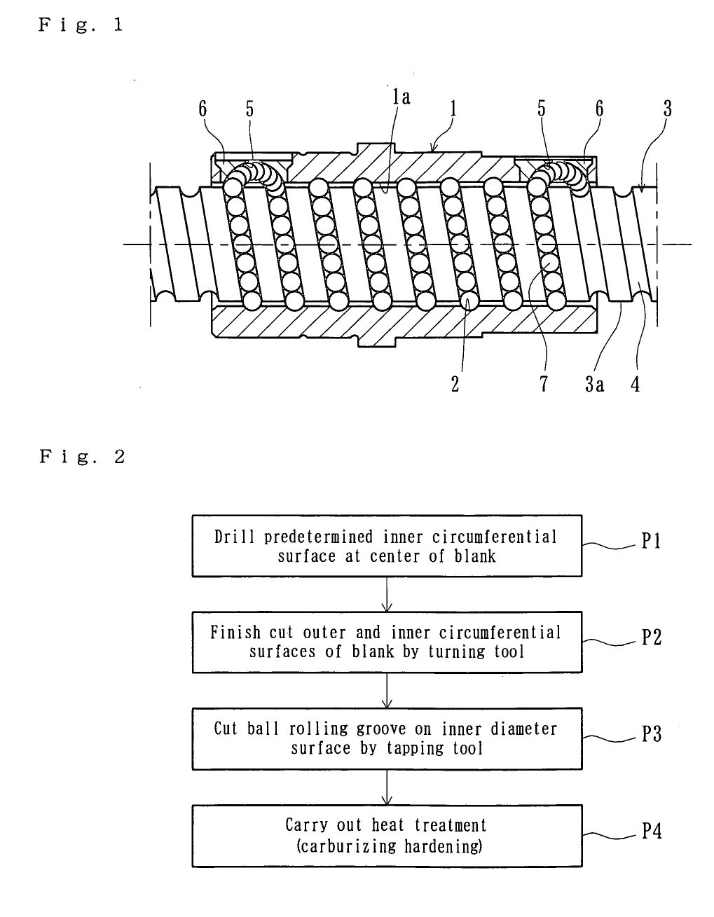

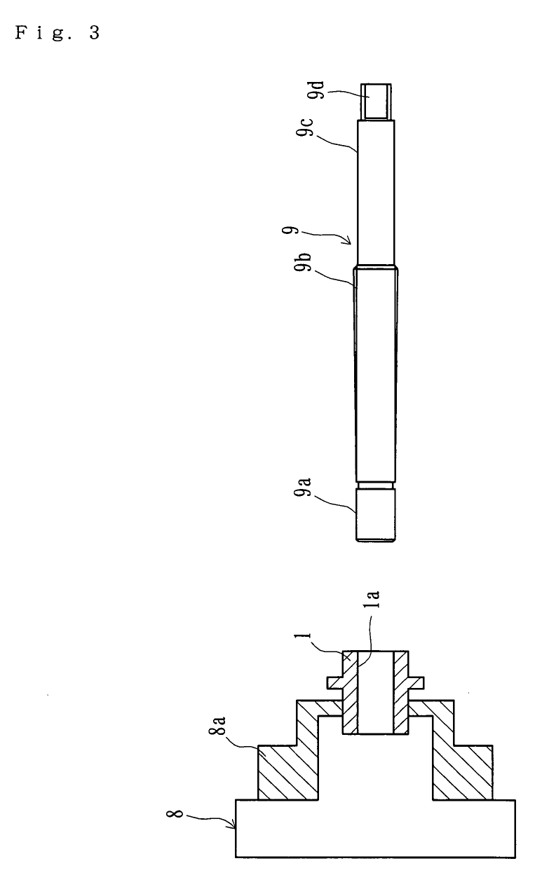

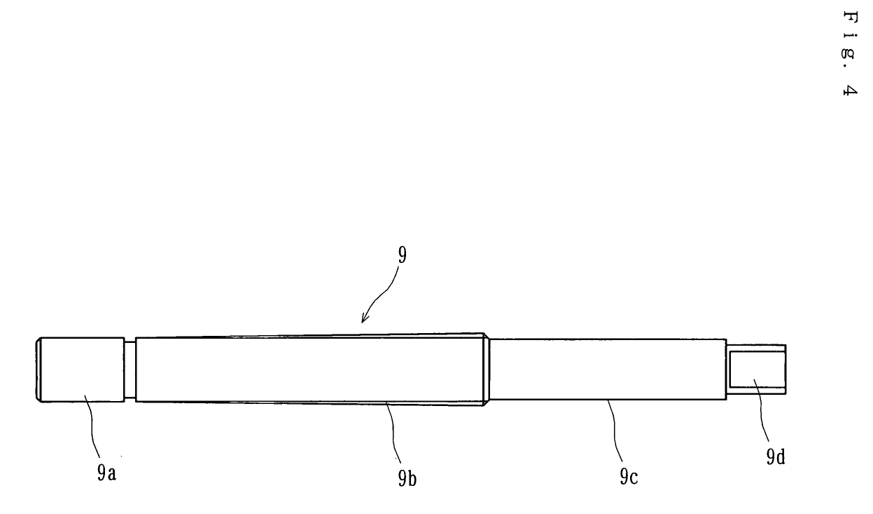

FIG. 1 is a longitudinal section view of an embodiment of a ball screw nut 1 of the present disclosure.

The ball screw nut 1 is made of case hardened steel such as SCM415 or SCM420 and is adapted to be fit onto a ball screw shaft 3. A helical ball rolling groove 2 is formed on an inner circumferential surface 1a. The groove 2 is arranged so that it oppositely faces a ball rolling groove 4 formed on an outer circumferential surface 3a of the ball screw shaft 3. Accordingly, the two grooves 2, 4 rollably contain a large number of balls 7 between them. The ball rolling groove 2 of the ball screw nut 1 is formed by cutting using a tapping tool 9, which will be described in more detail below. As well known in the art, the ball rolling grooves 2 and 4 form a ball rolling passage. A large number of balls 7 are circulated in an endless manner through a bridge member 6 formed with a connecting groove 5 to connect the ball rolling groove 2 of the ball screw nut 1. The system of ball circulation is not limited to the bridge member type and thus a return tube type or end cap type may be used.

FIG. 2 shows steps for manufacturing the ball screw nut 1 of the present disclosure. First, a predetermined inner circumferential surface is drilled at the center of a cylindrical blank (P1). The outer and inner circumferential surfaces of the blank are finished by cutting, using a turning tool (P2). The ball screw nut 1 and a tapping tool 9 are respectively mounted on a chuck 8a of a turning center 8 and a tail stock (not shown). The tapping tool 9 is inserted into the inner circumferential surface 1a of the ball screw nut 1 to cut it by rotating the ball screw nut 1 and the tapping tool 9 with NC controlling their phases (P3). Thus, the ball rolling groove 2 can be efficiently cut by one pass working. This achieves high accuracy working of the rolling groove at a low cost.

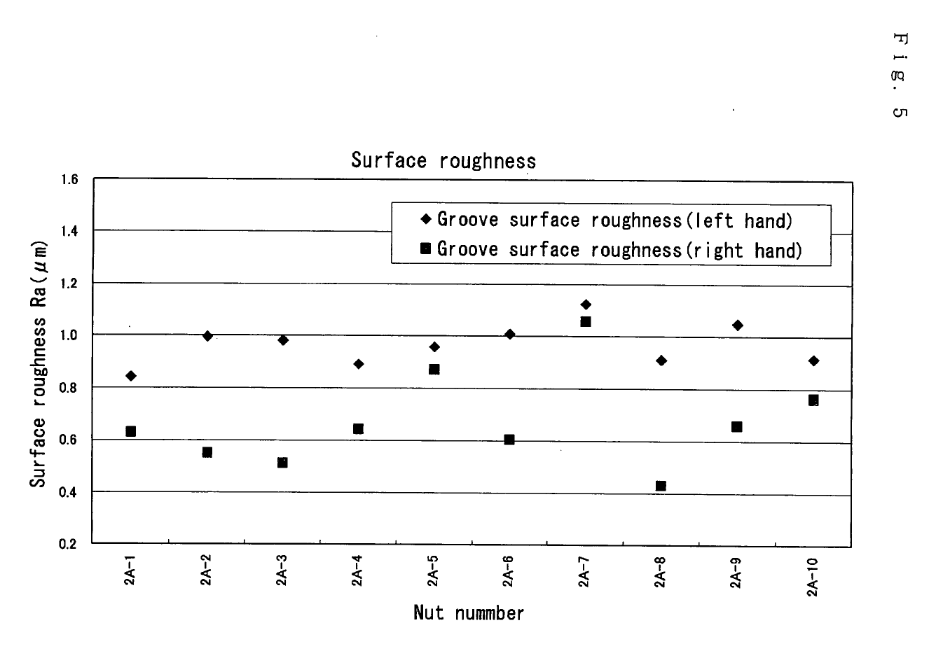

As shown in FIG. 4, the tapping tool 9 has a cylindrical portion 9a at its tip end. The tapping tool 9 is centered with the aid of guidance by the inner circumferential surface 1a. A cutting tooth portion 9b, of gradually increasing diameter, is arranged so that it extends rearward from the rear end of the cylindrical portion 9a. This cutting tooth portion 9b is followed by a shank portion 9d. Finally, a chuck portion 9d, of rectangular cross-section, is arranged at the end of the tapping tool 9 to enable it to be mounted on the tail stock. The ball rolling groove 2 can be cut on the inner circumferential surface 1a of the ball screw nut 1 by rotating the cutting tooth portion 9b of the tapping tool 9. The cutting tooth portion 9b of the tapping tool 9 is designed to form a Gothic arch groove with a combination of two arcs. Each arc has a radius of curvature slightly larger than the radius of each ball 7. Thus, the inner circumferential surface 1a of the ball screw nut 1 can be efficiently cut into a desired groove configuration by one pass of the tapping tool 9. In another example, the ball rolling groove 2 may be formed as a circular arc contacting with the ball 7 other than the Gothic arch configuration shown.

After having been tapped, the surface of the ball screw nut 1 is formed with a hardened layer, with a hardness of 54˜64 HRC, by carburizing hardening (P4). Although it is shown that the carburizing hardening is one example of heat treatment, it may be possible to use other heat treatments such as refining treatment, induction hardening, or dipping hardening when high carbon chrome steel is used as a blank.

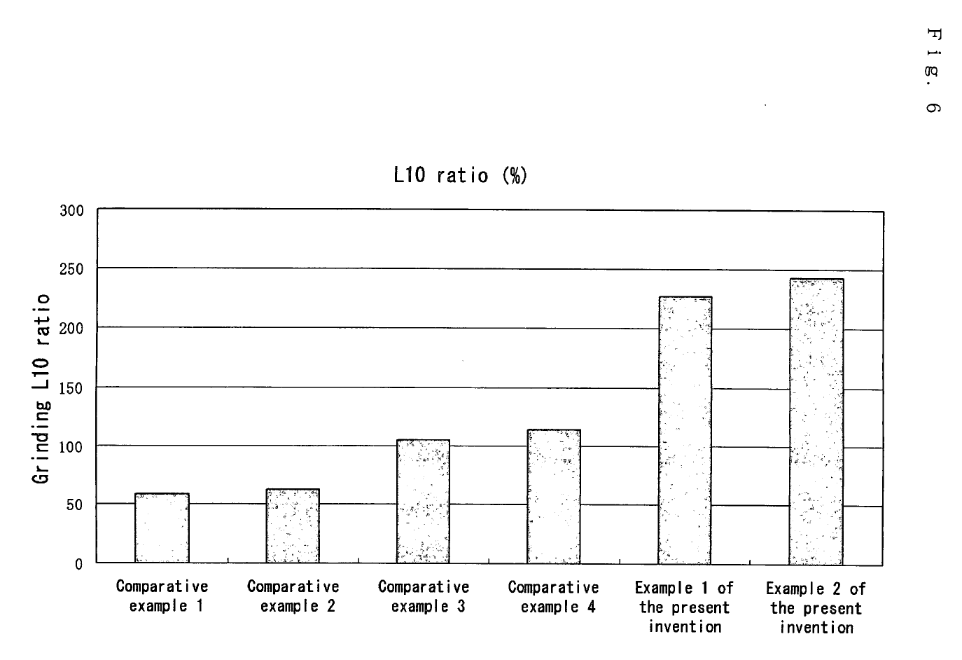

FIG. 5 is a graph of data showing the surface roughness of the ball rolling groove 2 of the ball screw nut 1. As can be seen in FIG. 5, the surface roughness Ra of the ball rolling groove 2 exhibits a maximum roughness of 1.2 μm and an average roughness less than or equal to 1.0 μm. Although these values are inferior to those which would be obtained by grinding, they are superior to the 1.5˜2.0 μm which are obtained by rolling. Thus according to the present teachings, it is possible to suppress noise or vibration of a ball screw at a high speed rotation.

FIG. 6 shows results of a life test of the ball screw with the ball screw nut 1 of the present disclosure. Specifications of the specimen are: shaft diameter=14.5 mm; lead angle=4 mm; ball diameter=2.778 mm; number of circulation=1 roll/4 rows; and circulating system=bridge type. Test conditions are: method of loading=constant pre-load by spring pre-load double nut; lubrication=oil VG68; number of rotation=2000 rpm; stroke=60 mm and load=2648N.

FIG. 6 is a graph showing a testing duration (i.e. time) from beginning of test to end of real life. The calculated L10 life time relative to the basic rated dynamic load of catalog indication is set as “100” on the basis of a ball screw having a ball rolling groove formed by grinding. As can be seen from the graph of FIG. 6, the ball screw nut 1 with a ball rolling groove 2 formed by the tapping tool 9, in accordance with the present disclosure has a sufficient durability. The “L10 ratio” of the present disclosure exhibits life more than twice that as compared with ball screws (comparative examples 1˜4) formed by prior art rolling.

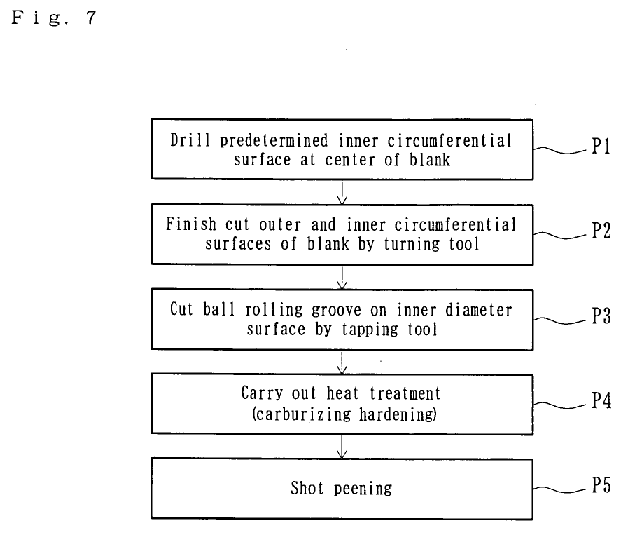

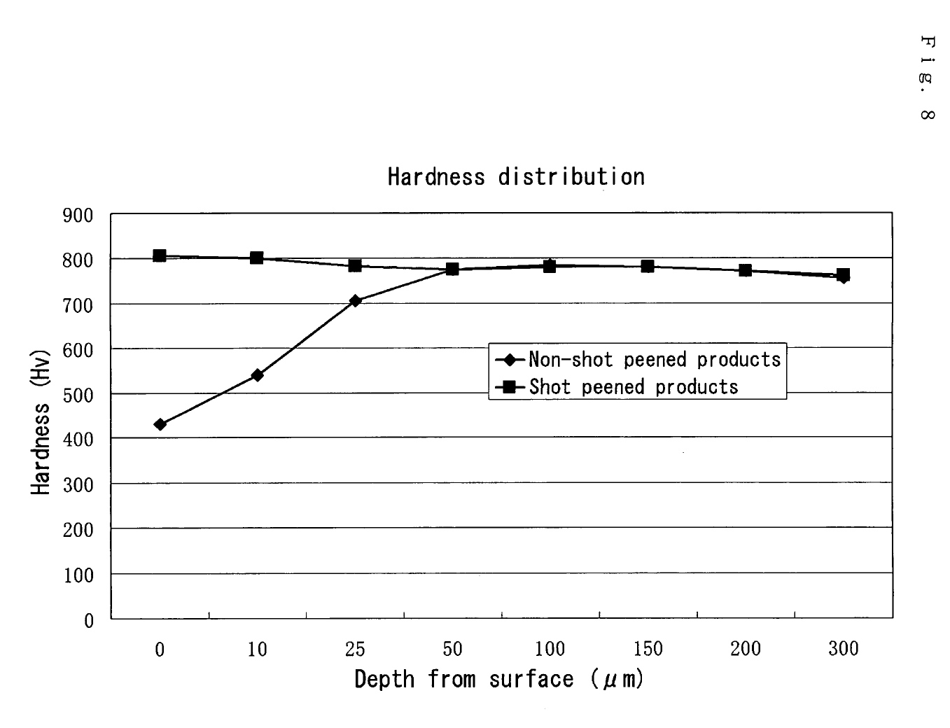

FIG. 7 is a flow chart showing other steps for manufacturing the ball screw nut of the present disclosure. This manufacturing method is fundamentally the same as steps P1˜P4 (from step P1 for drilling of the inner circumferential surface to step P4 for heat treatment) as those previously described with reference to FIG. 2. Accordingly, repeated description of them will be avoided. The following description will be made with reference to the ball screw nut previously described (FIG. 1).

After the heat treatment step (P4), the ball rolling groove 2 of the ball screw nut 1 of FIG. 1 is shot peened (P5). In this embodiment, the shot peening is carried out by using steel beads having high specific gravity and hardness. Specifically, particle size=40˜60 μm, shot pressure=0.4 MPa, and peening duration=60 sec. The shot peening enables the scale removal generated by heat treatment. This improves the surface roughness and increases the surface hardness and residual compressive stress of the groove surface. The shot peening may be carried out by using ceramic beads or glass beads other than steel beads.

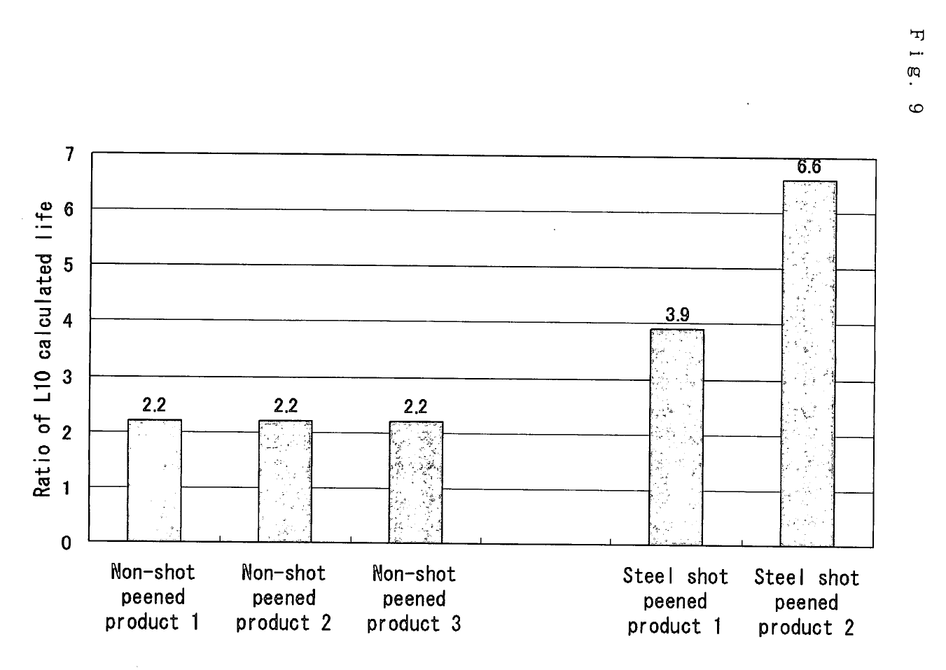

The surface roughness Ra after shot peening is improved to Ra=0.89 μm compared to an average value 1.05 μm before shot peening. Accordingly, noise or vibration of the ball screw can be suppressed even though it is at high rotational speed. As shown in FIG. 8, the surface hardness of non-shot peened products is low in a depth range of 0˜25 μm from their surfaces and can have out grain boundary oxidation region at their surfaces. On the other hand, it can be seen that the surface hardness of the shot peened products is increased and no grain boundary oxidation zone is found on their surfaces. The surface hardness was measured in a depth range 0˜300 μm from the surfaces of products near a zone where the balls 7 contact the ball rolling groove 2.

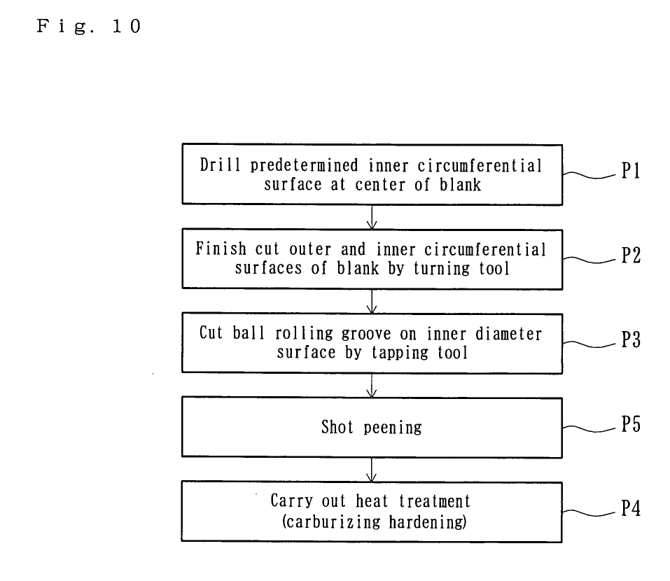

FIG. 9 shows results of a life test of the ball screw with the ball screw nut 1 of the present disclosure. Specifications of the specimen are: shaft diameter=14 mm; lead angle=4 mm; ball diameter=2.381 mm; number of circulation=1 roll/4 rows; and circulating system=bridge type. Test conditions are: method of loading=constant pre-load by spring pre-load double nut; lubrication=oil VG68; number of rotation=2000 rpm; stroke=60 mm and load=2400N.

FIG. 9 is a graph showing a ratio of a total number of rotations and a calculated total number of rotations (L10 life) until flaking are caused in the ball screw nut when a thrust load is applied. As can be seen from this graph, the shot peened products exhibit 2˜3 times the life as compared with those of non-shot peened products (comparative examples 1˜3). Thus, the shot peened products have sufficient durability.

It is preferable to set the surface hardness Hv at a range of about 700˜900 by shot peening. An improvement in life cannot be expected if less than or equal to Hv 700. Contrary, toughness is reduced if hardness is more than Hv 900. In addition, the residual compressive stress at the surface is preferable within a range of about −500˜−1500 MPa. A sufficient improvement in life of the ball screw nut cannot be expected if stress less than or equal to −500 MPa. Contrary, an increase of stress proportional to peening duration cannot be expected and thus manufacturing cost is increased if stress is more than −1500 MPa.

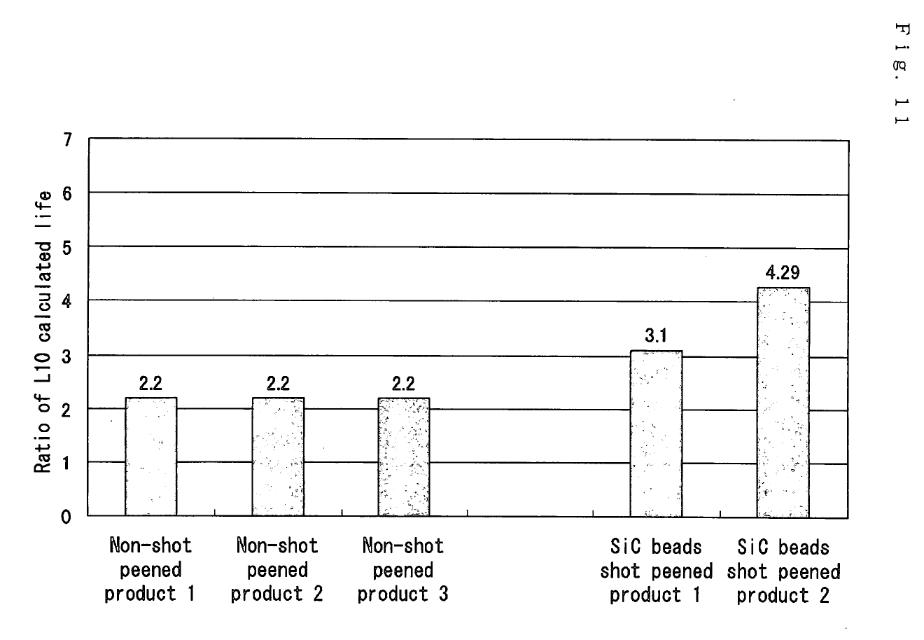

FIG. 10 shows another embodiment for manufacturing the ball screw nut 1 of the present disclosure. This manufacturing method is fundamentally the same in steps P1˜P3 (from step P1 for drilling of the inner circumferential surface to step P3 for tapping of the ball rolling groove 2) as those previously described with reference to FIG. 7. Accordingly, repeated description of them will be avoided.

In this embodiment, the shot peening (P5) of the ball rolling groove 2 is carried out after cutting of the ball rolling groove 2, before the heat treatment (P4). In this embodiment, the shot peening was carried out using silicon carbide beads, specifically, particle size=40˜60 μm, shot pressure=0.4 MPa, and peening duration=20 sec. Silicon carbide beads were not only used because the work (blank) is a so-called “green material” but because large plastic deformation of the work would be caused if steel beads were used and the configuration of the groove would be broken. The silicon carbide beads do not cause plastic deformation of the work and are well suited for refining the metallographic structure of the ultra-near surface (region of 2˜3 μm from surface) and for removing impurities generated by shot peening. Thus it is possible to improve the surface roughness of the ball rolling groove 2, scratched surface or chatter and to increase the surface hardness and the residual compressive stress of the surface.

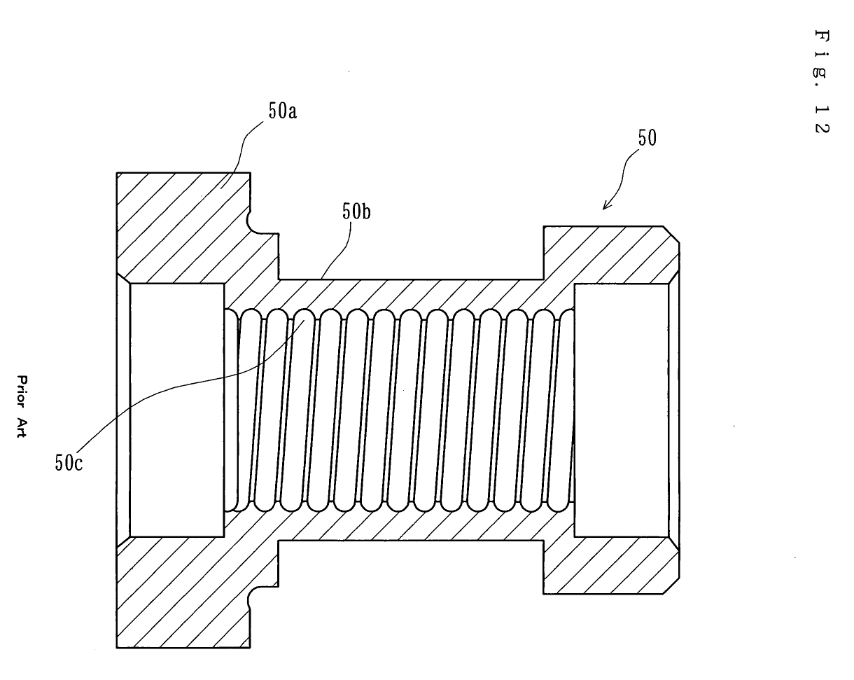

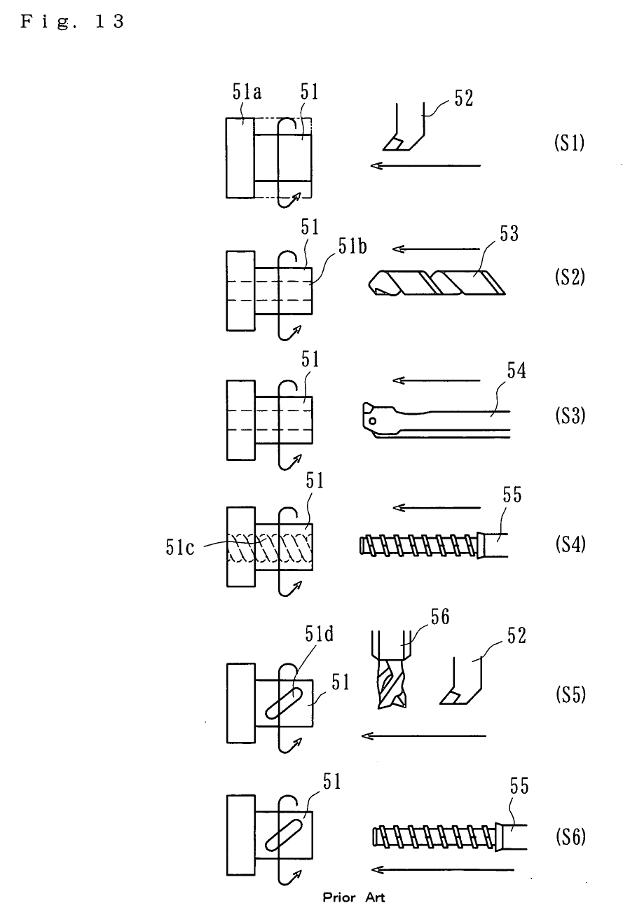

FIG. 11 shows results of a life test of the ball screw with the ball screw nut 1 of the present disclosure. Specifications of specimen and test conditions are same as those described with respect to previous embodiments. As can be seen from this graph of FIG. 11, the shot peened products exhibit 1.5˜2 times the life as compared with those of non-shot peened products (comparative examples 1˜3). Thus, the shot peened products have sufficient durability.

Since the shot peening (P5) is carried out after cutting (P3) and before heat treatment (P4), it is of course impossible to remove the grain boundary oxidation zone by heat treatment. However, it is appreciated that the improvement of the life of ball screw nut 1 is achieved by the increase of the surface hardness and residual compressive stress as well as the improvement of surface roughness, especially by improvement of the contacting condition between the ball rolling groove 2 and balls 7, which is obtained by smoothing rough cut surface. Thus, it is possible to carry out shot peening before and after heat treatment to further increase the wear resistance and durability in case of a ball screw used in a severe condition.

The ball screw nut of the present disclosure can be applied, especially to an automatic transmission of vehicle, an electric-powered brake, electric-powered power steering, an engine valve control actuator, and also to an electric-powered shock absorber and an actuator for controlling a width of CVT pulley.

Obviously, modifications and alternations will occur to those of ordinary skill in the art upon reading and understanding the preceding detailed description. It is intended that the present disclosure be construed as including all such alternations and modifications insofar as they come within the scope of the appended claims of their equivalents.

1-15. (canceled)

16. A ball screw nut with a ball rolling groove where balls roll on the inner circumferential surface of the ball screw nut comprising:
the ball rolling groove is formed by a surface generated by a tapping tool.

17. The ball screw nut of claim 16 wherein the ball rolling groove is formed as a Gothic arch configuration in cross-section.

18. The ball screw nut of claim 16 wherein the surface roughness Ra is limited to be less than or equal to 1.2 μm.

19. The ball screw nut of claim 16 wherein a surface of the ball rolling groove is formed with a hardened layer within a range of about 54˜64 HRC.

20. A method of manufacturing a ball screw nut with a ball rolling groove where balls roll on the inner circumferential surface of the ball screw nut comprising the steps of:
forming a predetermined inner circumferential surface at a center of a blank by a drilling tool;
generating the ball rolling groove by introducing a tapping tool into the inner circumferential surface; and
heat treating for hardening the surface of the ball rolling groove.

21. The method of claim 20 wherein the ball rolling groove is formed by cutting under NC control based on information obtained by detecting the phases of the ball screw nut and the tapping tool.

22. The method of claim 20 wherein the tip end portion of the tapping tool is formed as a cylindrical configuration guided through the inner circumferential surface.

23. A ball screw nut with a ball rolling groove where balls roll on the inner circumferential surface of the ball screw nut comprising the ball rolling groove is formed with a layer hardened by shot peening.

24. The ball screw nut of claim 23 wherein the surface roughness Ra is limited to be less than or equal to 1.0 μm.

25. The ball screw nut of claim 23 wherein the surface hardness Hv of the ball rolling groove is set within a range of 700˜900.

26. The ball screw nut of claim 23 wherein the surface of the ball rolling groove has the residual compressive stress within a range of about −500˜−1500 MPa.

27. A method for manufacturing a ball screw nut with a ball rolling groove where balls roll on the inner circumferential surface of the ball screw nut comprising:
shot peening is carried out before and/or after the heat treatment of the ball screw nut.

28. The method of claim 27 further comprising forming a predetermined inner circumferential surface at the center of a blank by a drilling tool and generating the ball rolling groove by introducing a tapping tool into the inner circumferential surface.

29. The method of claim 27 wherein the shot peening is carried out using silicon carbide beads having a particle size of 40˜60 μm.

30. The method of claim 27 wherein the shot peening is carried out using steel beads having a particle size of 40˜60 μm.
